(19) United States
(12) Patent Application Publication
(10) Pub. No.: US 2020/0161020 A1
(43) Pub. Date: May 21, 2020

(54) METHOD FOR ASSEMBLING AN ELECTRICAL CABLE WITH REDUCED SKIN EFFECT AND CORRESPONDING ELECTRICAL CABLE

(71) Applicant: NEXANS, Courbevoie (FR)

(72) Inventors: Thomas HAHNER, VERRIERES LE BUISSON (FR); Patrick RYBSKI, YERRES (FR)

(21) Appl. No.: 16/664,206

(22) Filed: Oct. 25, 2019

(30) Foreign Application Priority Data
Oct. 29, 2018 (FR) 18 59980

(51) Int. Cl. H01B 7/00; H01B 13/00; H01B 1/02; H01B 7/04

(52) U.S. Cl. CPC H01B 7/0009; H01B 7/04; H01B 1/02; H01B 13/0036

(57) ABSTRACT

An electrical cable has a cross section with an area of predetermined dimension. The cable is formed by a plurality of conductors electrically insulated from one another. A plurality of first bundles, each having at least three conductors, is formed (10), and, as long as the predetermined dimension is not reached, a plurality of (n+1)^{th} bundles each having at least three of the n^{th} bundles, n being an integer greater than or equal to 1, is iteratively formed (14).

### RELATED APPLICATION

This application claims the benefit of French Patent Application No. 18 59980, filed on Oct. 29, 2018, the entirety of which is incorporated by reference.

### BACKGROUND

### Field of the Invention

The present invention relates to a method for assembling a cable with reduced skin effect, and a corresponding electrical cable.

The invention relates to the field of the electrical cables passed through by alternating currents (either sinusoidal, or in pulse width modulation mode or any other non-continuous form), used, by way of a nonlimiting example, in aeronautical applications.

### Description of the Related Art

The current trend in aircraft propulsion is toward hybrid electrical, even purely electrical, systems.

The expected power levels are situated between 2 and 4 MVA for the hybrid propulsion systems and can reach 40 MVA for the entirely electrical propulsion systems.

That will require the transmission of electrical power through the cell of the aircraft on a hitherto unheard-of scale. For example, the electrical system will be able to use pulse width modulation (PWM) with a fundamental frequency greater than 1 kHz, voltage levels lying between 1 kV and 3 kV (even higher) and currents of several hundreds of amperes.

Although works are currently being conducted to find appropriate electrical insulation systems which can withstand voltages of this order of magnitude, including taking into account the flight altitude of the aircraft concerned, which implies a low pressure, there are no known works aiming to optimize the organization of the conductors.

Now, currents of several hundreds of amperes require conductors that have a cross section with a large area, that is to say conductors of high diameter.

The abovementioned high frequencies, greater than 1 kHz, combined with the large areas of the cross sections of the conductors, lead to a significant increase in the resistance of these conductors, passed through by alternating currents, compared to the direct current resistance, and this is because of the skin effect or pellicular effect, which means that, at high frequency, the current tends to circulate only at the surface of the conductor.

As an example, for an aluminium conductor of AWG000 type, that is to say whose cross-sectional area is 85 mm², the resistance increases by the order of 45% at a frequency of 1 kHz. To offset this increase in resistance, it would be necessary to increase the cross section of the conductor. That is not optimal, particularly in an embedded aeronautical application, where any increase in the weight induces a rise in fuel consumption.

There is therefore a need to design cables with reduced skin effect.

The increase in the resistance because of the skin effect is a phenomenon that is also known in the field of high-voltage terrestrial cables operating at low frequency, typically between 50 Hz and 60 Hz, but whose cross section has a very large area, typically greater than 1000 mm². In this field, in order to reduce the skin effect, conductors are used that are formed by several segments or sectors, known as Milliken conductors.

However, this type of conductor is very rigid and optimized for low frequencies. It cannot therefore be used for aeronautical applications.

Another type of conductor is known, known as Litz conductors, high frequency, having cross sections of small area, typically a few mm², and which operate at frequencies of several tens of kHz, even more.

Nevertheless, the conductors of Litz type are generally enamelled. One drawback with enamel is that it has to be eliminated when installing cables composed of these conductors. The elimination of the enamel is done generally by welding. Now, welding is prohibited in aeronautical applications, because of the risk of breaking of the conductor in case of vibrations.

In order to reduce the skin effect it is necessary to guarantee that the same current circulates in each individual conductor of the cable. For that, it is necessary for the individual conductors to be electrically insulated. That is not however sufficient. Indeed, if the conductors forming the cable are assembled in concentric layers, the cable behaves electrically as a solid cylindrical cable and does so even if the conductors are electrically insulated from one another.

### OBJECTS AND SUMMARY

The aim of the present invention is to remedy the abovementioned drawbacks of the prior art.

To this end, the present invention proposes a method for assembling an electrical cable whose cross section has an area of predetermined dimension, this cable being formed by a plurality of conductors electrically insulated from one another, noteworthy in that it comprises steps consisting in:

forming a plurality of first bundles each comprising at least three conductors; and

as long as the predetermined dimension is not reached, iteratively forming a plurality of (n+1)^{th} bundles each comprising at least three of the n^{th} bundles, n being an integer greater than or equal to 1.

Thus, the conductors forming the cable are assembled such that each of them passes successively through various points of the cross section of the cable as it progresses in the axial direction of the cable. By virtue of this disposition, the movement of the current by skin effect can occur only in an individual conductor, if the frequency is sufficiently high.

Furthermore, it is sufficient for the electrical insulation between adjacent conductors to offer a contact resistance several times greater than the resistance of an individual conductor for a length such that it passes through all the points of the cross section of the cable. Such a resistance is of the order of a few mΩ. Consequently, an insulation resistance of a few ohms between the individual conductors is sufficient in practice.

In a particular embodiment, the at least three conductors of the first bundles are disposed such that the central points of their cross sections are on one and the same circle and the at least three n^{th} bundles are disposed such that the central points of their cross sections are on one and the same circle.

Thus, the conductors forming the cable are assembled such that each of them passes successively through all the points of the cross section of the cable as the conductor progresses in the axial direction of the cable. That even further reduces the skin effect.

In a particular embodiment, each of the first bundles comprises between three and five conductors.

In a particular embodiment, for each value of the integer n, each of the (n+1)^{th} bundles comprises between three and five of the n^{th} bundles.

In a particular embodiment, the integer n takes, successively, the values 1 to 3.

According to one possible particular feature, the conductors are made of aluminium.

That makes it possible to obtain a natural electrical insulation, given that the surface of the aluminium conductors is naturally oxidized and that this layer of oxide is non-conductive.

For the same purpose as that indicated above, the present invention also proposes an electrical cable formed by a plurality of conductors electrically insulated from one another, noteworthy in that it is obtained by the implementation of an assembly method as briefly described above.

In a particular embodiment, this cable is an aeronautical cable.

Since the advantages and the particular features of the cable are similar to those of the assembly method, they are not repeated here.

### BRIEF DESCRIPTION OF THE DRAWINGS

Other aspects and advantages of the invention will emerge on reading the following detailed description of particular embodiments, given as nonlimiting examples, with reference to the attached drawings, in which:

FIG. 1 is a flow diagram illustrating steps of a method of assembling an electrical cable according to the present invention, in a particular embodiment;

FIG. 2 is a schematic representation of the cross section of first bundles of conductors assembled according to an assembly method according to the present invention, in particular embodiments;

FIG. 3 is a schematic representation of the cross section of second bundles of conductors assembled according to an assembly method according to the present invention, in particular embodiments; and

FIG. 4 is a schematic representation of the cross section of third bundles of conductors assembled according to an assembly method according to the present invention, in particular embodiments.

### DETAILED DESCRIPTION

In the context of the present invention, an electrical cable is considered that has a cross section with a predetermined area. This cable is formed by several conductors. These conductors are electrically insulated from one another.

The cable can for example be an aeronautical cable, used for example onboard an aeroplane.

The electrical insulation of the conductors can be produced by any means. It is advantageously obtained naturally when the conductors are made of aluminium, because a layer of aluminium oxide, electrically insulating, is naturally formed on the surface of such conductors.

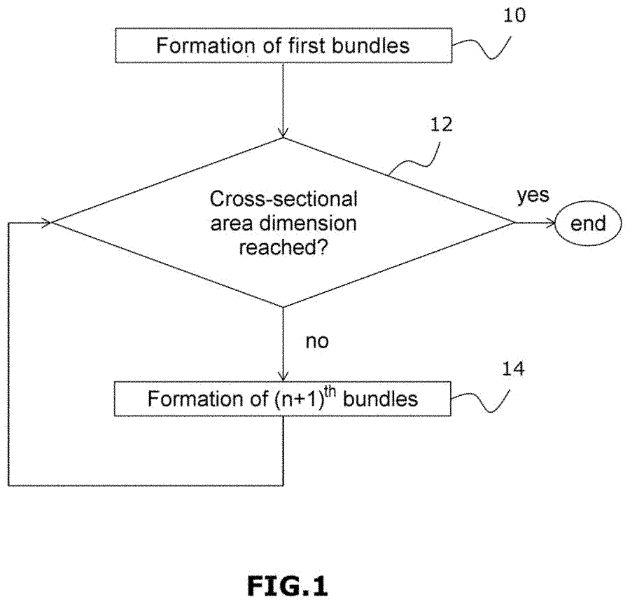

As the flow diagram of FIG. 1 shows, the method, according to the invention, of assembling an electrical cable formed by several conductors electrically insulated from one another comprises a first step 10 consisting in forming several first bundles of conductors.

In a particular embodiment, each first bundle comprises at least three conductors.

Advantageously, each first bundle comprises between three and five conductors.

The conductors are held together in each bundle by simple twist effect, without it being necessary to provide any particular fixing means between the conductors.

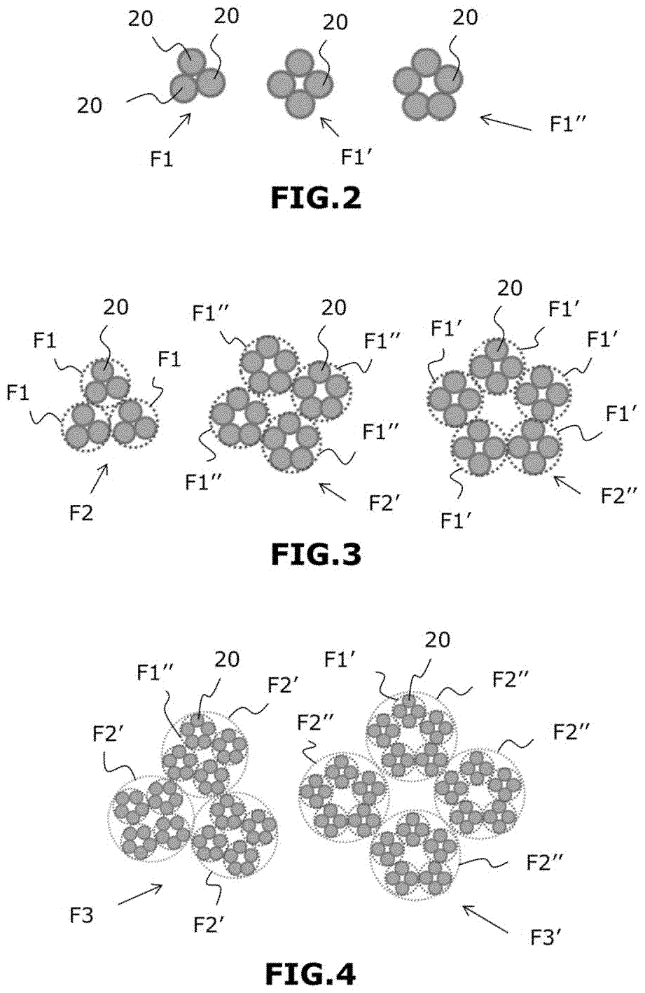

FIG. 2 illustrates the cross section of a first bundle of conductors 20 in three different exemplary embodiments: from left to right, there are represented a first example in which the first bundle F1 comprises three conductors 20, a second example in which the first bundle F1′ comprises four conductors 20 and a third example in which the first bundle F1″ comprises five conductors 20.

In these three exemplary embodiments, the conductors 20 of each first bundle F1 or F1′ or F1″ are disposed such that the central points of the cross section of these conductors 20 are situated on one and the same circle. This disposition is particularly advantageous because it allows each conductor 20 to occupy successively, as it progresses along the axis of the cable, at least a part of all of the points of the cross section of this cable, even all the points of the cross section of the cable if the length of the cable is sufficient for that.

Thus, at high frequency, the skin effect will occur only within a conductor 20. The current will thus circulate in all the conductors 20 and will not be confined to the surface of the cable.

At the end of the step 10 of formation of the first bundles F1 or F1′ or F1″ of conductors 20, in a test 12, a determination is made as to whether the area of the cross section of the cable has reached the desired dimension.

If such is the case, the cable assembly method is terminated.

Otherwise, in the next step 14, second bundles of conductors 20, each comprising at least three first bundles, are formed. The first bundles used to form a second bundle advantageously all have the same number of conductors 20.

FIG. 3 illustrates the cross section of a second bundle of conductors 20 in three different exemplary embodiments: from left to right, there are represented a first example in which the second bundle F2 comprises three first bundles F1 each comprising three conductors 20, a second example in which the second bundle F2′ comprises four first bundles F1″ each comprising five conductors 20 and a third example in which the second bundle F2″ comprises five first bundles F1′ each comprising four conductors 20.

In these three exemplary embodiments, the first bundles included in each second bundle F2 or F2′ or F2″ are disposed such that none of the first bundles is located at the centre of the second bundle. That amounts to having the central points of the cross sections of the first bundles situated on one and the same circle. This disposition is particularly advantageous because it allows each conductor 20 to occupy, successively as it progresses along the axis of the cable, at least a part of all the points of the cross section of this cable, even all the points of the cross section of the cable if the length of the cable is sufficient for that.

As at the end of the step 10 of formation of the first bundles, in the test 12, at the end of the step 14 of formation of the second bundles, a test is carried out as to whether the dimension desired for the area of the cross section of cable formed by the second bundles has been reached.

If such is the case, the cable assembly method is terminated.

Otherwise, the iteration consisting in forming, in step 14, (n+1)^{th} bundles each comprising at least three n^{th} bundles, n being an integer greater than or equal to 1, is continued.

Advantageously, for each value of the integer n, each of the (n+1)^{th} bundles comprises between three and five n^{th} bundles.

Thus, FIG. 4 illustrates the cross section of a third bundle of conductors 20 in two different exemplary embodiments: from left to right, there are represented a first example in which the third bundle F3 comprises three second bundles F2′ each comprising four first bundles F1″ of five conductors 20 and a second example in which the third bundle F3′ comprises four second bundles F2″ each comprising five first bundles F1′ of four conductors 20.

In these two exemplary embodiments, the second bundles of each third bundle F3 or F3′ are disposed such that none of the second bundles is located at the centre of the third bundle. That amounts to having the central points of the cross sections of the second bundles situated on one and the same circle. This disposition is particularly advantageous because it allows each conductor 20 to occupy, successively as it progresses along the axis of the cable, at least a part of all the points of the cross section of this cable, even all the points of the cross section of the cable if the length of the cable is sufficient for that.

As a nonlimiting example, the integer n can take, successively, the values 1 to 3. Thus, in an example in which the first bundles each comprise 4 conductors (like the bundle F1′), the second bundles each comprise 4 first bundles (like the bundle F2′), the third bundles each comprise 4 second bundles and the fourth bundles each comprise 4 third bundles, the cable is formed by the assembly of [4×(4×(4×(4×4)]=1024 conductors.

Conventional aluminium cables are generally formed by conductors of 0.37 mm diameter. This diameter has been chosen as a good trade-off between flexibility and complexity of the cable and is also sufficiently small to make it possible to avoid an increase in the resistance due to the skin effect at the frequencies concerned.

The cross sections of cable required to withstand high currents lie between AWG00 and AWG0000. A conventional AWG000 cable is an assembly of 19 concentric bundles, each bundle being composed of 44 conductors of 0.37 mm diameter, i.e. 836 conductors in total.

In the abovementioned example of the invention with a cable with reduced skin effect comprising [4×(4×(4×(4×4)]=1024 conductors assembled according to the method of the invention, the diameter of the conductors can be reduced to 0.334 mm.

Another nonlimiting example consists in assembling [4×(4×(4×(3×4)]=768 conductors according to the invention. In this other example, the diameter of the conductors ought to be increased to 0.39 mm.

Measurement makes it possible to confirm that, whereas for an AWG000 cable, the increase in the resistance is 45% (compared to the direct current resistance) at a frequency of 1 kHz, the increase in resistance for an AWG000 cable assembled according to the present invention is negligible for frequencies ranging up to 5 kHz. The resistance of an AWG000 cable according to the invention is therefore 45% lower than that of a conventional AWG000 cable.

1. Method for assembling an electrical cable whose cross section has an area of predetermined dimension, said cable being formed by a plurality of conductors electrically insulated from one another, said method comprising the steps of:
forming a plurality of first bundles each comprising at least three conductors; and
as long as said predetermined dimension is not reached, iteratively forming a plurality of (n+1)^{th} bundles each comprising at least three of the n^{th} bundles, n being an integer greater than or equal to 1.

2. Method according to claim 1, wherein said at least three conductors of said first bundles are disposed such that the central points of their cross sections are on one and the same circle and said at least three n^{th} bundles are disposed such that the central points of their cross sections are on one and the same circle.

3. Method according to claim 1, wherein each of said first bundles comprises between three and five conductors.

4. Method according to claim 1, wherein, for each value of said integer n, each of said (n+1)^{th} bundles comprises between three and five of said n^{th} bundles.

5. Method according to claim 1, wherein said integer n takes, successively, the values 1 to 3.

6. Method according to claim 1, wherein said conductors are made of aluminium.

7. Electrical cable formed by a plurality of conductors electrically insulated from one another, wherein said electrical cable is obtained by the implementation of an assembly method according to claim 1.

8. Electrical cable according to claim 1, wherein said electrical cable is an aeronautical cable.
